(19) United States
(12) Patent Application Publication
(10) Pub. No.: US 2020/0173618 A1
(43) Pub. Date: Jun. 4, 2020

(54) DECORATIVE SOLAR-POWERED LIGHTING SYSTEM, A DECORATIVE SOLAR MODULE OVERLAY, AND A DECORATIVE SOLAR MODULE ASSEMBLY FOR A DECORATIVE SOLAR-POWERED LIGHTING SYSTEM

(71) Applicant: Evergreen Enterprises of Virginia, LLC, Richmond, VA (US)

(72) Inventors: Paul D. Maguire, Goochland, VA (US); Linda Scott MUSANTE, Midlothian, VA (US); Fei QIU, Richmond, VA (US); Jeffrey A. MORA, Midlothian, VA (US)

(21) Appl. No.: 16/206,598

(22) Filed: Nov. 30, 2018

(51) Int. Cl. F21S 9/03; H02S 20/30; H02S 40/30

(52) U.S. Cl. CPC F21S 9/032; F21W 2121/00; H02S 40/30; H02S 20/30

(57) ABSTRACT

A solar-powered lighting system, a decorative solar module overlay for such a solar-powered lighting system, and a solar module assembly for such a solar-powered lighting system. The solar-powered lighting system is configured to permit receipt of sunlight by the solar module while also concealing the solar module and enhancing the overall aesthetic appearance of the solar-powered lighting system.

### TECHNICAL FIELD

Embodiments relate to a solar-powered lighting system, a decorative solar module overlay for such a solar-powered lighting system, and a solar module assembly for such a solar-powered lighting system.

### BACKGROUND

Solar-powered lighting systems offer a convenient way to illuminate an outdoor or indoor area while eliminating the need for plugging the system into an external power source, such as, for example, a wall outlet. Existing solar-powered lighting systems having a decorative structural design provide an aesthetically enhanced product that offers both a decor piece and an illuminating feature.

One problem that exists with existing solar-powered lighting products is the unappealing appearance of the solar module that is incorporated into the product. Generally, the solar modules in these products do not blend in with or compliment the overall product. This leaves the decorative product with a feature that is necessary to the function of the product, but disturbs the aesthetic of the product.

While solar-powered lighting systems are currently available, there exists a need for a solar-powered lighting system that conceals or enhances the aesthetic appearance of the solar module.

### SUMMARY

Embodiments herein relate to a solar-powered lighting system, a solar module assembly for such a solar-powered lighting system, and a decorative solar module overlay for such a solar-powered lighting system.

Embodiments herein relate to a solar-powered lighting system that is configured to permit receipt of adequate sunlight by the solar module while simultaneously concealing the solar module and enhancing the overall aesthetic appearance of the solar-powered lighting system.

### DRAWINGS

Embodiments will be illustrated by way of example in the drawings and explained in the description hereinbelow.

FIG. 1 is a front perspective view of an embodiment of a solar-powered lighting system.

FIG. 2 is a top perspective view of an embodiment of the solar-powered lighting system of FIG. 1, that includes a solar module assembly with a solar module overlay in an operating position.

FIG. 3 is a side view of the solar-powered lighting system of FIG. 1, with the solar module overlay in an operating position.

FIG. 4 is a perspective view of the solar-powered lighting system of FIG. 1, with the solar module overlay in a non-operating position.

FIG. 5 is a top view of the solar module overlay for the solar-powered lighting system of FIG. 1.

FIG. 6 is a bottom perspective view of an embodiment of a solar-powered lighting system having a solar module overlay in an operating position.

FIG. 7 is a top view of an overlay of an embodiment of a solar module overlay for a solar-powered lighting system.

### DESCRIPTION

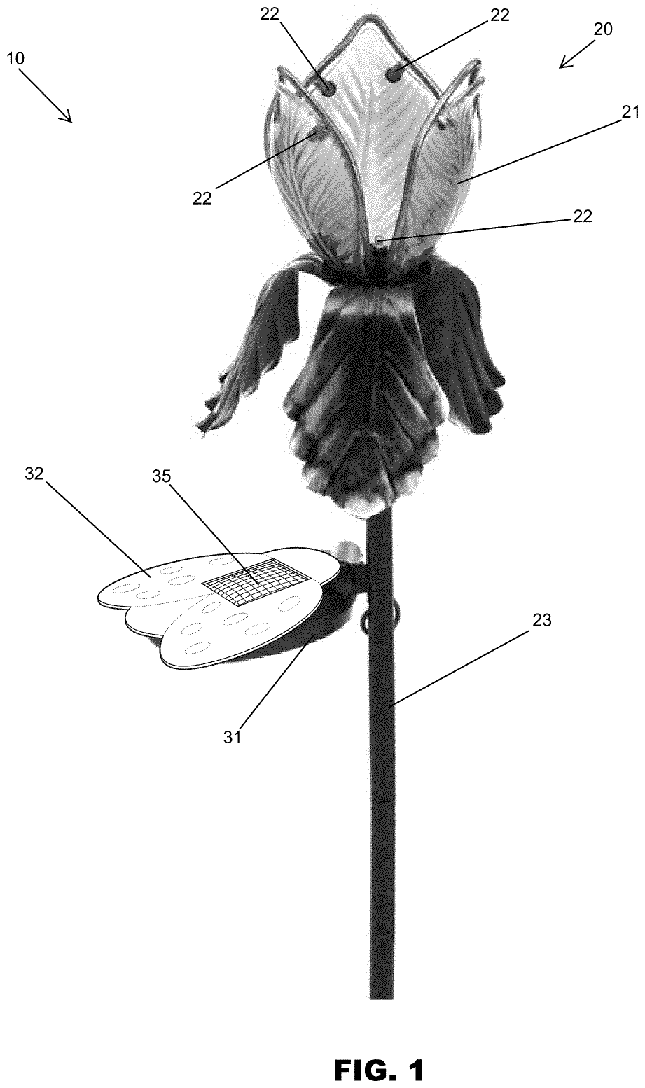

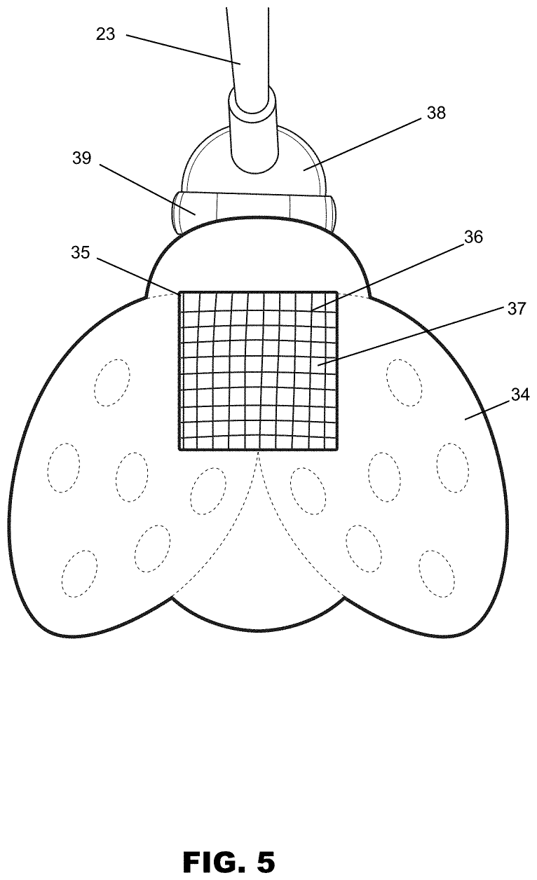

As illustrated in FIGS. 1 through 7, embodiments relate to a decorative solar-powered lighting system 10 that includes a light assembly 20 to emit light, and a solar module assembly 30 to serve as a power source for the light assembly 20.

As illustrated in FIG. 1, the light assembly 20 includes a decorative luminary or lantern 21 and one or more light sources 22 arranged on the decorative luminary to produce light. In accordance with embodiments, the light source(s) 22 may comprise, for example, light emitting diodes (LED), a reflective bulb, or an incandescent bulb.

The light assembly 20 includes a support base 23 for placement on an underlying support surface in a room of a home, an open area of a lawn, patio, garden or the like. The support surface may be a natural one that includes the ground of the lawn, garden or the like, or an artificial one that is to be placed on and/or over the lawn, garden or the like. The support base 23 comprises a shaft having a longitudinal axis which is insertable into the support surface to support or otherwise anchor the solar-powered lighting system 10 in the support surface. Instead of insertion into the support surface, the support base 23 may comprise one or more feet to support or otherwise anchor the solar-powered lighting system 10 on the support surface. Examples of such alternative anchoring devices, include, but are not limited to, a weighted base, anchor, four-point spike, and any other device that permits practice of the embodiments.

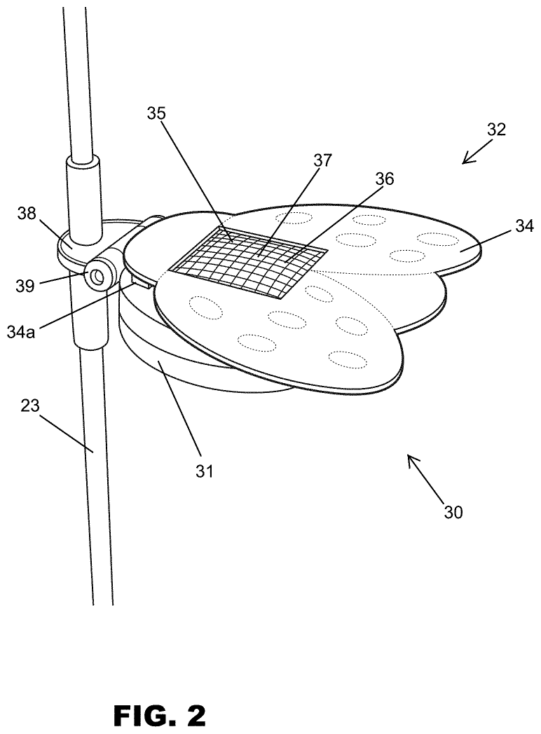

As illustrated in FIGS. 2 through 5, the solar module assembly 30 is to serve as a power source for the light sources 21. The solar module assembly 30 may be arranged for removeable support on the support base 23 of the light assembly 20 via a connector such as, for example, a bracket 38. The solar module assembly 30 includes a solar module 31 having one or more solar panels 33 forming an array to collect sunlight, and a solar module overlay 32 to at least partially conceal the solar module 31 while also enhancing the overall aesthetic appeal of the solar module 31. Particularly, the solar module overlay 32 is configured to permit sunlight to reach the solar panel(s) 33. In that way, the overall aesthetic appeal of the solar-powered lighting system 10 is not diminished by the solar module 31, while also permitting receipt of adequate sunlight to the solar panel(s) 33. In accordance with embodiments, the solar module 31 further includes at least one battery (not illustrated), and wiring electrically connecting the solar module 31 to the light assembly 20. The at least one battery may comprise, for example, a rechargeable battery.

In accordance with embodiments, the solar module overlay 32 may comprise a body 34 having a decorative design, and a mesh grid 35 connected to the body 34. Although the illustrated embodiment features the decorative body 34 as a ladybug, embodiments are not limited thereto, and may have any decorative configuration or design that will fall within the spirit and scope of the principles of this disclosure.

For example, the decorative body 34 may define an interior space or opening into which the mesh grid 35 is removeably or permanently received in a manner that connects the decorative body 34 and the mesh grid 35 at one or more connection regions/points. Although the illustrated embodiment features the interior opening with a substantially rectangular cross section, embodiments are not limited thereto, and may have any geometric cross-section that will fall within the spirit and scope of the principles of this disclosure. The decorative body 34 and the mesh grid 35 may be connected to each other, for example, by tack-welding, an adhesive, or a mechanical connector(s). Embodiments, however, are not limited thereto and may encompass other ways of connecting the decorative body 34 and the mesh grid 35 that will fall within the spirit and scope of the principles of this disclosure.

In accordance with embodiments, the mesh grid 35 may comprise a plurality of thin rods 36 that are interwoven to define gaps 37 therebetween. The gaps 37 are to permit sunlight to penetrate therethrough and reach the solar panel(s) 33 of the solar module 31. The mesh grid 35 may have an overall area that at least corresponds to the overall area of the solar panel(s) 33. Embodiments, however, are not limited thereto and may include a mesh grid 35 having an overall area that overlaps the overall area of the solar panel(s) 33.

In accordance with embodiments, the decorative body 34 and the mesh grid 35 may be composed of a metal material, or any other material that is suitable for indoor and/or outdoor use. The decorative body 34 and the mesh grid 35 may be composed of the same or different materials. The decorative body 34 may be colored, shaped and/or patterned to resemble any decorative item, such as, for example, a ladybug, a leaf, or a flower. The mesh grid 35 may also be decorative in that it may be painted or positioned in relation to the decorative body 34 to become part of the overall decorative design. For example, the decorative body 34 may have a structure to resemble petals of a flower, and the mesh grid 35 may be positioned and/or colored to resemble the center of the flower. Embodiments, however, are not limited thereto, and thus, may encompass an unlimited number of decorative designs and configurations.

In accordance with embodiments, the solar module overlay 32 may comprise a mesh grid without a decorative body. In such an embodiment, the solar module overlay 32 may have a decorative design insofar as it may be colored, patterned, and/or shaped to resemble a flower, a ladybug, a leaf, or the like.

In accordance with embodiments, the solar module overlay 32 may be connected to the solar module 31 for pivoting movement about a pivot axis. For example, the solar module overlay 32 may be connected to the solar module via a mechanical hinge 39. A first hinge region end of the hinge 39 is connected to the solar module 31 at a first connection region while a second hinge region of the hinge 39 is connected to the solar module overlay 32 at a second connection region. The second connection region facilitates movement of the solar module overlay 32 between an operating position (i.e., pivoted downwardly with respect to the solar module 31) in which the mesh grid 35 is positioned directly over the solar panel(s) 33, and a non-operating position (i.e., pivoted upwardly with respect to the solar module 31) in which the mesh grid 35 is positioned away from the solar panel(s) 33. The non-operating position permits a user to directly access the solar module 31 for purposes of cleaning, repair, replacement, replace batteries, etc. Embodiments, however, are not limited thereto and may include alternative devices to connect the solar module overlay 32 to the solar module 31 that will fall within the spirit and scope of the principles of this disclosure.

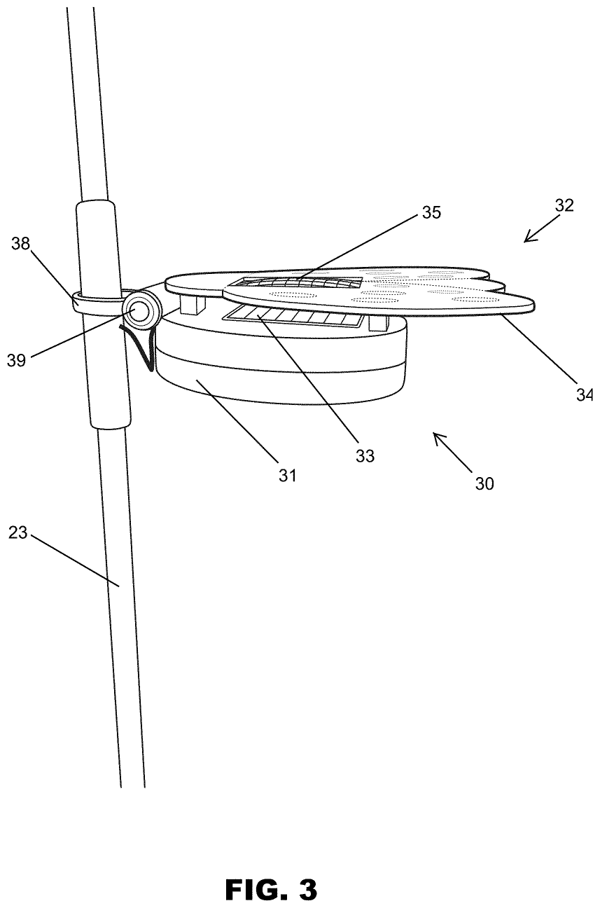

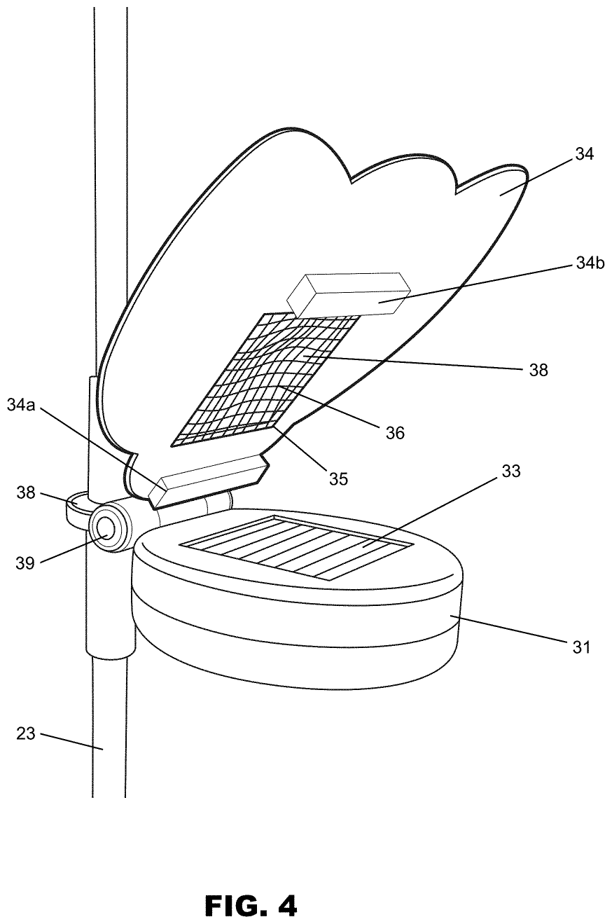

As illustrated in FIGS. 3 and 4, in accordance with embodiments, the solar module overlay 32 is connected to the solar module 31 in a manner that does not obstruct the upper surface of the solar module 31. Meaning, the solar module overlay 32 is connected to the solar module 31 in a manner that permits a flow of rain, water, debris, etc. off the upper surface of the solar module 31. To accomplish this, the decorative body 34 comprises spaced apart bumpers 34a, 34b arranged to be positioned between the solar module overlay 32 and the solar module 31 in an operating position of the solar module overlay 32. For example, the bottom surface of the decorative body 34, which is to face the upper surface of the solar module 33 in the operating position of the solar module overlay 32, may be provided with bumpers 34a, 34b (attached thereto as separate components or incorporated into the decorative body 34) which protrude from the bottom surface and directly contact the upper surface of the solar module 31. In that way, when the solar module overlay 32 is in the operating position, a gap is created between the solar module 31 and the solar module overlay 32. This gap is to permit rain, water, debris, etc. to flow off the upper surface of the solar module 31 when the solar module overlay 32 is in the operating position. Embodiments, however, are not limited thereto and may include alternative manners to permit fluid flow from the surface of the solar module 31 that will fall within the spirit and scope of the principles of this disclosure.

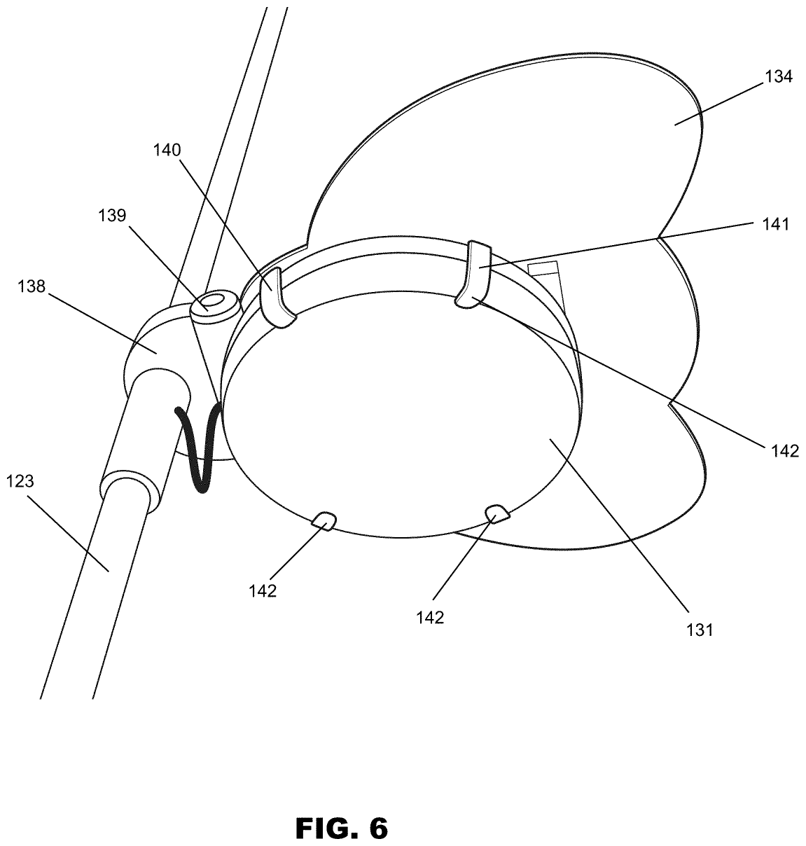

As illustrated in FIG. 6, in accordance with embodiments, alternatively or additionally, the solar module overlay 132 may be connected to the solar module 131 by at least one tab/prong 140 having a first section 141 that extends downwardly from the decorative body 134 and a second section 142 that extends substantially perpendicularly from the first section 141 to abut or contact the bottom surface of the solar module 131 in a manner that secures the solar module overlay 132 to the solar module 131. The connection may be removed, for example, by retracting the tab/prong 140 away from the solar module 131.

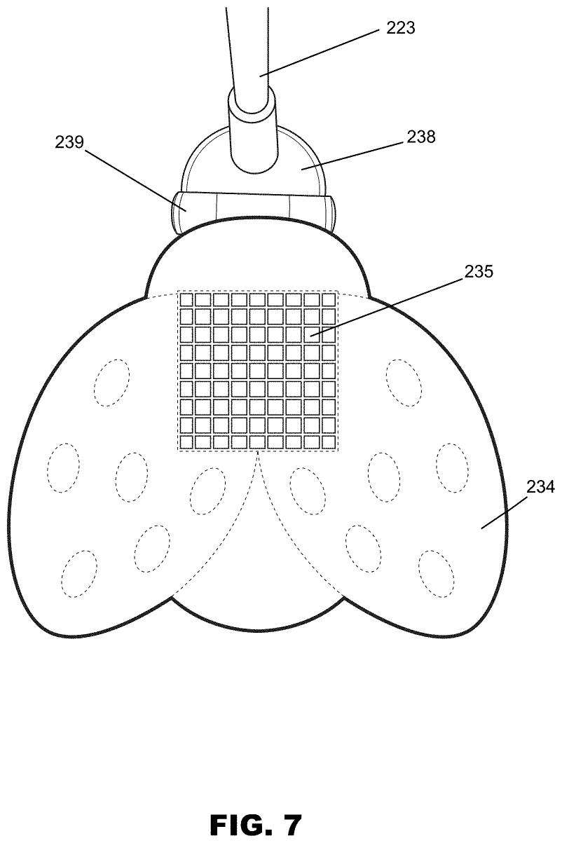

As illustrated in FIG. 7, in alternative embodiment, the solar module overlay 232 may not include a mesh grid, but instead, may comprise a decorative body 234 having a plurality of apertures 235 sized and positioned to permit sunlight to reach the at solar panel(s) of the solar module.

Embodiments relate to a solar-powered outdoor lighting system, a decorative solar module overlay for such a solar-powered outdoor lighting system, and a solar module assembly for such a solar-powered lighting system. Those skilled in the art will appreciate from the description provided herein that the broad techniques of the embodiments can be implemented in a variety of forms. Therefore, while the embodiments are described in connection with particular examples thereof, the true scope of the embodiments should not be so limited since other modifications will become apparent to the skilled practitioner upon a study of the drawings and description.

Embodiments described herein may be incorporated into or onto a variety of ornamental devices and are not limited to the designs provided herein. Such ornamental devices may include garden stakes, lanterns, hanging mobiles, birdbaths, birdhouses, birdfeeders, garden statuaries, yard lights, tabletop decor or any other indoor, garden, or outdoor decorative item that illuminates.

In accordance with embodiments, the ornamental device may comprise a variety of decorative items, such as, for example, garden stakes, lanterns, hanging mobiles, birdbaths, birdhouses, birdfeeders, garden statuaries, yard lights, and tabletop decor. Embodiments, however, are not limited thereto and may encompass other decorative items that will fall within the spirit and scope of the principles of this disclosure.

As an example, embodiments may include a solar module assembly in which a solar module is arranged at the top of a lantern to provide solar power to a luminary in the lantern, whereby the solar module is to receive sunlight through a solar module overlay. The solar module overlay is to enhance the overall aesthetic appearance of the solar module, so that the solar module does not disturb the overall aesthetic appearance of the solar-powered lighting system.

As an additional example, embodiments may include a solar module affixed to a garden stake to power a luminary component of the garden stake. The overlay of the embodiment similarly enhances the aesthetic appearance of the solar module, or conceals the solar module, so that the solar module does not disturb the aesthetic appearance of the solar-powered lighting system.

Additional Notes and Examples:

Example One may include a solar-powered lighting system, comprising: a light assembly to emit light; and a solar module assembly electrically connected to the light assembly to serve as a power source for the light assembly, the solar module assembly including a solar module having one or more solar panels forming an array to collect sunlight, and a solar module overlay to cover and at least partially conceal the solar module while also permitting receipt of sunlight to the solar panels.

Example Two may include the solar-powered lighting system of Example One, wherein the light assembly comprises a decorative lantern and one or more light sources arranged on the decorative lantern.

Example Three may include the solar-powered lighting system of Example Two, wherein the solar module overlay comprises: a solar module overlay body having a decorative design defining an interior opening, the solar module overlay body configured to cover and at least partially conceal the solar module, and a mesh grid received in the interior opening, the mesh grid including a plurality of rods interwoven to define gaps which permit sunlight to penetrate therethrough and reach the solar panels.

Example Four may include the solar-powered lighting system of Example One, wherein the solar module overlay comprises a solar module overlay body having a decorative design defining a plurality of apertures which permit sunlight to penetrate therethrough and reach the solar panels.

Example Five may include the solar-powered lighting system of Example One, further comprising a connector mechanism to connect the solar module overlay and the solar module for pivoting movement of the solar module overlay relative to the solar module between an operating position in which the mesh grid is positioned directly over the solar panels, and a non-operating position in which the mesh grid is positioned away from the solar panels.

Example Six may include the solar-powered lighting system of Example One, wherein the connector mechanism comprises a hinge having: a first hinge region connected to the solar module at a first connection region, and a second hinge region connected to the solar module overlay at a second connection region that facilitates movement of the solar module overlay between the operating position and the non-operating position.

Example Seven may include the solar-powered lighting system of Example 1: wherein the solar module overlay comprises at least one bumper that protrudes from a bottom surface thereof to directly contact the upper surface of the solar module for positioning between the solar module overlay and the solar module in an operating position of the solar module overlay.

Example Eight may include the solar-powered lighting system of Example One, further comprising at least one prong having a first prong section that extends downwardly from the solar module overlay and a second prong section that extends substantially perpendicularly from the first prong section to abut or contact the bottom surface of the solar module and secure the solar module overlay to the solar module.

Example Nine may include a solar module assembly to serve as a power source for a light assembly, the solar module assembly comprising: a solar module having one or more solar panels forming an array to collect sunlight; and a solar module overlay to cover and at least partially conceal the solar module while also permitting receipt of sunlight to the solar panels.

Example Ten may include the solar module assembly of Example Nine: wherein the solar module overlay comprises: a solar module overlay body having a decorative design defining an interior opening, the solar module overlay body configured to cover and at least partially conceal the solar module, and a mesh grid received in the interior opening, the mesh grid including a plurality of rods interwoven to define gaps which permit sunlight to penetrate therethrough and reach the solar panels.

Example Eleven may include the solar module assembly of Example Nine, wherein the solar module overlay comprises a solar module overlay body having a decorative design defining a plurality of apertures which permit sunlight to penetrate therethrough and reach the solar panels.

Example Twelve may include the solar module assembly of Example Nine, further comprising a connector mechanism to connect the solar module overlay and the solar module for pivoting movement of the solar module overlay relative to the solar module between an operating position in which the mesh grid is positioned directly over the solar panels, and a non-operating position in which the mesh grid is positioned away from the solar panels.

Example Thirteen may include the solar module assembly of Example Nine, wherein the connector mechanism comprises a hinge having: a first hinge region connected to the solar module at a first connection region, and a second hinge region connected to the solar module overlay at a second connection region that facilitates movement of the solar module overlay between the operating position and the non-operating position.

Example Fourteen may include the solar module assembly of Example Nine: wherein the solar module overlay comprises at least one bumper that protrudes from a bottom surface thereof to directly contact the upper surface of the solar module for positioning between the solar module overlay and the solar module in an operating position of the solar module overlay.

Example Fifteen may include the solar module assembly of Example Nine, further comprising at least one prong having a first prong section that extends downwardly from the solar module overlay and a second prong section that extends substantially perpendicularly from the first prong section to abut or contact the bottom surface of the solar module and secure the solar module overlay to the solar module

Example Sixteen may include a solar module overlay for a solar module having one or more solar panels forming an array to collect sunlight, the solar module overlay comprising: a solar module overlay body having a decorative design defining an interior opening, the solar module overlay body configured to cover and at least partially conceal the solar module; and a mesh grid received in the interior opening, the mesh grid including a plurality of rods interwoven to define gaps which permit sunlight to penetrate therethrough and reach the solar panels.

Example Seventeen may include the solar module overlay of Example Sixteen, further comprising a connector mechanism to connect the solar module overlay and the solar module for pivoting movement of the solar module overlay relative to the solar module between an operating position in which the mesh grid is positioned directly over the solar panels, and a non-operating position in which the mesh grid is positioned away from the solar panels.

Example Eighteen may include the solar module overlay of Example Sixteen, wherein the connector mechanism comprises a hinge having: a first hinge region connected to the solar module at a first connection region, and a second hinge region connected to the solar module overlay at a second connection region that facilitates movement of the solar module overlay between the operating position and the non-operating position.

Example Nineteen may include the solar module overlay of Example Sixteen, wherein the solar module overlay comprises at least one bumper that protrudes from a bottom surface thereof to directly contact the upper surface of the solar module for positioning between the solar module overlay and the solar module in an operating position of the solar module overlay.

Example Twenty may include the solar module overlay of Example Sixteen, further comprising at least one prong having a first prong section that extends downwardly from the solar module overlay and a second prong section that extends substantially perpendicularly from the first prong section to abut or contact the bottom surface of the solar module and secure the solar module overlay to the solar module.

The terms “coupled,” “attached,” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

What is claimed is:

1. A solar-powered lighting system, comprising:
a light assembly to emit light; and
a solar module assembly electrically connected to the light assembly to serve as a power source for the light assembly, the solar module assembly including a solar module having one or more solar panels forming an array to collect sunlight, and a solar module overlay to cover and at least partially conceal the solar module while also permitting receipt of sunlight to the solar panels.

2. The solar-powered lighting system of claim 1, wherein the light assembly comprises a decorative lantern and one or more light sources arranged on the decorative lantern.

3. The solar-powered lighting system of claim 1, wherein the solar module overlay comprises:
a solar module overlay body having a decorative design defining an interior opening, the solar module overlay body configured to cover and at least partially conceal the solar module, and
a mesh grid received in the interior opening, the mesh grid including a plurality of rods interwoven to define gaps which permit sunlight to penetrate therethrough and reach the solar panels.

4. The solar-powered lighting system of claim 1, wherein the solar module overlay comprises a solar module overlay body having a decorative design defining a plurality of apertures which permit sunlight to penetrate therethrough and reach the solar panels.

5. The solar-powered lighting system of claim 1, further comprising a connector mechanism to connect the solar module overlay and the solar module for pivoting movement of the solar module overlay relative to the solar module between an operating position in which the mesh grid is positioned directly over the solar panels, and a non-operating position in which the mesh grid is positioned away from the solar panels.

6. The solar-powered lighting system of claim 1, wherein the connector mechanism comprises a hinge having:
a first hinge region connected to the solar module at a first connection region, and
a second hinge region connected to the solar module overlay at a second connection region that facilitates movement of the solar module overlay between the operating position and the non-operating position.

7. The solar-powered lighting system of claim 1, wherein the solar module overlay comprises at least one bumper that protrudes from a bottom surface thereof to directly contact the upper surface of the solar module for positioning between the solar module overlay and the solar module in an operating position of the solar module overlay.

8. The solar-powered lighting system of claim 1, further comprising at least one prong having a first prong section that extends downwardly from the solar module overlay and a second prong section that extends substantially perpendicularly from the first prong section to abut or contact the bottom surface of the solar module and secure the solar module overlay to the solar module.

9. A solar module assembly to serve as a power source for a light assembly, the solar module assembly comprising:
a solar module having one or more solar panels forming an array to collect sunlight; and
a solar module overlay to cover and at least partially conceal the solar module while also permitting receipt of sunlight to the solar panels.

10. The solar module assembly of claim 9, wherein the solar module overlay comprises:
a solar module overlay body having a decorative design defining an interior opening, the solar module overlay body configured to cover and at least partially conceal the solar module, and
a mesh grid received in the interior opening, the mesh grid including a plurality of rods interwoven to define gaps which permit sunlight to penetrate therethrough and reach the solar panels.

11. The solar module assembly of claim 9, wherein the solar module overlay comprises a solar module overlay body having a decorative design defining a plurality of apertures which permit sunlight to penetrate therethrough and reach the solar panels.

12. The solar module assembly of claim 9, further comprising a connector mechanism to connect the solar module overlay and the solar module for pivoting movement of the solar module overlay relative to the solar module between an operating position in which the mesh grid is positioned directly over the solar panels, and a non-operating position in which the mesh grid is positioned away from the solar panels.

13. The solar module assembly of claim 9, wherein the connector mechanism comprises a hinge having:
a first hinge region connected to the solar module at a first connection region, and
a second hinge region connected to the solar module overlay at a second connection region that facilitates movement of the solar module overlay between the operating position and the non-operating position.

14. The solar module assembly of claim 9, wherein the solar module overlay comprises at least one bumper that protrudes from a bottom surface thereof to directly contact the upper surface of the solar module for positioning between the solar module overlay and the solar module in an operating position of the solar module overlay.

15. The solar module assembly of claim 9, further comprising at least one prong having a first prong section that extends downwardly from the solar module overlay and a second prong section that extends substantially perpendicularly from the first prong section to abut or contact the bottom surface of the solar module and secure the solar module overlay to the solar module.

16. A solar module overlay for a solar module having one or more solar panels forming an array to collect sunlight, the solar module overlay comprising:
a solar module overlay body having a decorative design defining an interior opening, the solar module overlay body configured to cover and at least partially conceal the solar module; and
a mesh grid received in the interior opening, the mesh grid including a plurality of rods interwoven to define gaps which permit sunlight to penetrate therethrough and reach the solar panels.

17. The solar module overlay of claim 16, further comprising a connector mechanism to connect the solar module overlay and the solar module for pivoting movement of the solar module overlay relative to the solar module between an operating position in which the mesh grid is positioned directly over the solar panels, and a non-operating position in which the mesh grid is positioned away from the solar panels.

18. The solar module overlay of claim 16, wherein the connector mechanism comprises a hinge having:
a first hinge region connected to the solar module at a first connection region, and
a second hinge region connected to the solar module overlay at a second connection region that facilitates movement of the solar module overlay between the operating position and the non-operating position.

19. The solar module overlay of claim 16, wherein the solar module overlay comprises at least one bumper that protrudes from a bottom surface thereof to directly contact the upper surface of the solar module for positioning between the solar module overlay and the solar module in an operating position of the solar module overlay.

20. The solar module overlay of claim 16, further comprising at least one prong having a first prong section that extends downwardly from the solar module overlay and a second prong section that extends substantially perpendicularly from the first prong section to abut or contact the bottom surface of the solar module and secure the solar module overlay to the solar module.
